(19) United States
(12) Patent Application Publication
(10) Pub. No.: US 2014/0139899 A1
(43) Pub. Date: May 22, 2014

(54) DISPLAY DEVICE

(71) Applicant: Kabushiki Kaisha Toshiba, Minato-ku (JP)

(72) Inventors: Aira HOTTA, Kanagawa-ken (JP); Akihisa MORIYA, Kanagawa-ken (JP); Takashi SASAKI, Kanagawa-ken (JP); Haruhiko OKUMURA, Kanagawa-ken (JP); Masashi NISHIYAMA, Kanagawa-ken (JP); Goh ITOH, Tokyo (JP)

(73) Assignee: Kabushiki Kaisha Toshiba, Minato-ku (JP)

(21) Appl. No.: 14/074,238

(22) Filed: Nov. 7, 2013

(30) Foreign Application Priority Data
Nov. 20, 2012 (JP) 2012-254574

(51) Int. Cl. G02B 26/02

(52) U.S. Cl. CPC G02B 26/02
USPC 359/227

(57) ABSTRACT

A display device includes an image display, an optical component, a light control component. The image display emits light including an image. The optical component has a focal distance D1. The light control component is provided between the image display and the optical component on an optical path of the light. The light control component includes a central aperture transmitting a first portion of the light emitted, and a peripheral aperture provided around the central aperture and transmitting a second portion of the light. The light control component blocks a portion of the light other than the first and second portions. The focal distance D1, a distance D2 between the optical component and the light control component, and an aperture spacing d0 between the central aperture and the peripheral aperture satisfy a relationship: d0·D1/D2>2.

### CROSS-REFERENCE TO RELATED APPLICATIONS

This application is based upon and claims the benefit of priority from the Japanese Patent Application No. 2012-254574, filed on Nov. 20, 2012; the entire contents of which are incorporated herein by reference.

### FIELD

Embodiments described herein relate generally to a display device.

### BACKGROUND

A focus-free head mounted display (HMD) has been proposed. In such a HMD, an image is projected directly onto, for example, the retina without utilizing the adjustment function of the eye.

For example, a focus-free effect is obtained by using a pinhole optical system in which a pinhole is provided on the optical path. In the focus-free optical system, the region (the viewing zone) where the image can be viewed is substantially one point. The display can be viewed by matching the position of the eye to the one point. It is difficult to match the position of the eye to the one point; and it is difficult to use and view the display. Also, there is a configuration in which multiple pinholes are provided.

### BRIEF DESCRIPTION OF THE DRAWINGS

FIG. 1A and FIG. 1B are schematic views showing a display device according to a first embodiment;

FIG. 2 is a schematic perspective view showing the display device according to the first embodiment;

FIG. 3 is a schematic view showing the display device according to the first embodiment;

FIG. 4A to FIG. 4I are schematic views showing characteristics of display devices;

FIG. 5 is a schematic view showing characteristics of the display device according to the first embodiment;

FIG. 6 is a schematic view showing another display device according to the first embodiment;

FIG. 7A to FIG. 7C are schematic views showing other display devices according to the first embodiment;

FIG. 8A to FIG. 8B are schematic views showing other display devices according to the first embodiment;

FIG. 9 is a schematic view showing another display device according to the first embodiment; and

FIG. 10 is a schematic view showing a display device according to a second embodiment.

### DETAILED DESCRIPTION

According to one embodiment, a display device, includes an image display, an optical component, a light control component. The image display is configured to emit light including an image. The optical component has a focal distance D1. The light control component is provided between the image display and the optical component on an optical path of the light. The light control component includes a central aperture configured to transmit a first portion of the light emitted from the image display, and a peripheral aperture provided around the central aperture and configured to transmit a second portion of the light. The light control component is configured to block a portion of the light other than the first portion and the second portion. The focal distance D1 (millimeters), a distance D2 (millimeters) between the optical component and the light control component, and an aperture spacing d0 (millimeters) between the central aperture and the peripheral aperture are configured to satisfy a relationship:

d0·D1/D2>2 (millimeters).

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

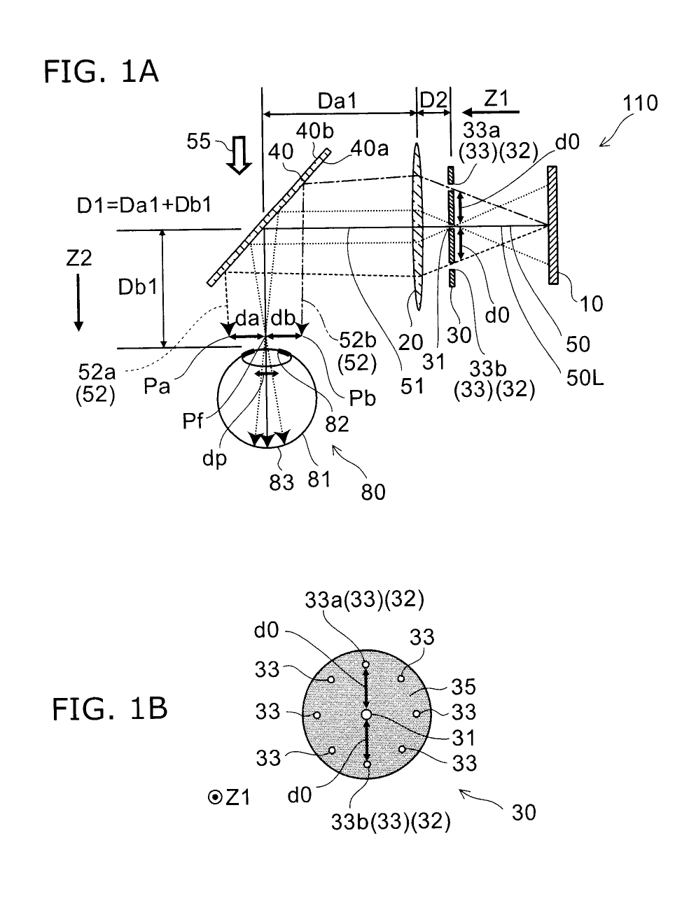

FIG. 1A and FIG. 1B are schematic views illustrating a display device according to a first embodiment.

As shown in FIG. 1A, the display device 110 according to the embodiment includes an image display component or unit 10, an optical component or unit 20, and a light control component or unit 30.

The image display unit 10 emits light 50 including an image. The image display unit 10 includes, for example, a liquid crystal layer or an organic EL layer. The image display unit 10 may include, for example, a liquid crystal display device, an organic EL display device, etc. For example, a laser drawing-type display element may be used as the image display unit 10. The image display unit 10 may include any display element.

The optical unit 20 has a focal distance D1 (a first distance D1 (millimeters (mm)). In the example, a convex lens is used as the optical unit 20. As described below, a concave mirror may be used as the optical unit 20.

The light control unit 30 is provided on an optical path 50L of the light 50 between the image display unit 10 and the optical unit 20. At least a portion of the light 50 emitted from the image display unit 10 is incident on the light control unit 30. The light control unit 30 blocks a portion of the light 50 and transmits another portion.

The light 50 that passes through the light control unit 30 is incident on the optical unit 20. The light 50 emitted from the optical unit 20 is concentrated from the optical unit 20 at a focal position Pf of the optical unit 20. The focal position Pf is a position on the optical path 50L.

In the example, the display device 110 further includes a reflective layer 40. The reflective layer 40 is provided on the optical path 50L between the light control unit 30 and a position (the focal position Pf) separated from the optical unit 20 by the focal distance. The reflective layer 40 has a first major surface 40a and a second major surface 40b. The second major surface 40b is a surface on the side opposite to the first major surface 40a. The reflective layer 40 reflects the light 50 at the first major surface 40a. The reflective layer 40 transmits at least a portion of light (background light 55) that is incident on the second major surface 40b.

An eye 81 of a user (a human viewer 80) using the display device 110 is disposed proximally to the focal position Pf. The light 50 is incident on a retina 83 by passing through a pupil 82 of the eye 81. The light 50 is imaged on the retina 83. In the example, the light 50 that passes through the optical unit 20 travels toward the eye 81 by being reflected by the first major surface 40a of the reflective layer 40. The human viewer 80 views the image included in the light 50. Also, the human viewer 80 views the image of the background of the background light 55 that is incident on the second major surface 40b of the reflective layer 40. For example, the human viewer 80 can simultaneously view the image in the light 50 and the background image. The image in the light 50 is superimposed onto the background image. For example, as a background image, an image that includes an arrow is displayed to indicate a travel direction corresponding to a road of the background image.

In the embodiment, the optical path 50L is bent instead of having one linear configuration. In the example, the optical path 50L is bent by the reflective layer 40. In the example, the image display unit 10, the light control unit 30, and the optical unit 20 are arranged on one straight line. The light of the optical path 50L that passes through the image display unit 10, the light control unit 30, and the optical unit 20 travels along a Z1 axis. The light travels along a Z2 axis after being reflected by the reflective layer 40. For example, the Z2 axis is non-parallel to the Z1 axis.

FIG. 1B illustrates the configuration of the light control unit 30. FIG. 1B illustrates the configuration when the light control unit 30 is projected onto a plane perpendicular to the optical path 50L.

As shown in FIG. 1B, the light control unit 30 has a central aperture 31 and a peripheral aperture 32 (which can be made of plural subapertures as shown).

For example, a light-shielding unit 35 is provided in the light control unit 30. The central aperture 31 and the peripheral aperture 32 may be provided in the light-shielding unit 35.

The central aperture 31 is, for example, a pinhole. The peripheral aperture 32 is provided around the central aperture 31. In the example, the peripheral aperture 32 has multiple subapertures 33. The multiple subapertures 33 are, for example, sub-pinholes.

The multiple subapertures 33 are arranged, for example, along a concentric circle having the central aperture 31 as a center. The multiple subapertures 33 include, for example, a first subaperture 33a and a second subaperture 33b. The central aperture 31 is disposed between the first subaperture 33a and the second subaperture 33b.

For example, a metal plate may be used as the light control unit 30. The metal plate is used as the light-shielding unit 35. Multiple holes are provided in the metal plate; and one of the holes is used as the central aperture 31. The other holes are used as the peripheral aperture 32 (the multiple subapertures 33).

A light-shielding film such as, for example, a metal, carbon, etc., alternatively may be used as the light control unit 30. The light-shielding film is provided, for example, on a transparent substrate. The light-shielding film is used as the light-shielding unit 35. The portion of the substrate where the light-shielding film is not provided is used as the central aperture 31 and the peripheral aperture 32 (the multiple subapertures 33).

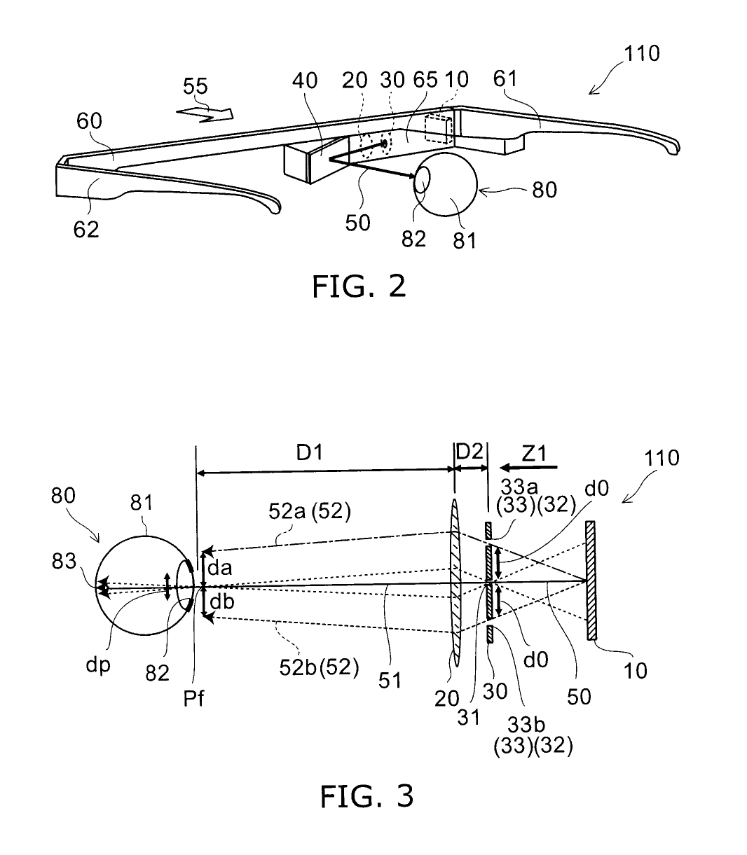

FIG. 2 is a schematic perspective view illustrating the display device according to the first embodiment.

As shown in FIG. 2, the display device 110 may further include a holder 60.

The holder 60 holds the image display unit 10, the optical unit 20, the light control unit 30, and the reflective layer 40. For example, a housing 65 is provided in the holder 60. For example, the image display unit 10, the optical unit 20, the light control unit 30, and the reflective layer 40 are contained in the housing 65.

For example, the holder 60 includes a right-side holding member 61 and a left-side holding member 62. The right-side holding member 61 is designed to contact a right-side portion (e.g., proximal to the ear on the right side) of the head of the human viewer 80. The left-side holding member 62 is designed to contact a left-side portion (e.g., proximal to the ear on the left side) of the head of the human viewer 80. Thereby, the holder 60 regulates the spatial disposition between the image display unit 10, the optical unit 20, the light control unit 30, the reflective layer 40, and the eye 81 of the human viewer 80. The holder 60 regulates, for example, the spatial disposition between the light control unit 30 and the eye 81 of the human viewer 80 on which the light emitted from the light control unit 30 is incident. Due to the holder 60, the light 50 is stably incident on the eye 81; and a stable display is possible.

As shown in FIG. 1A, the central aperture 31 transmits a first portion 51 of the light 50 emitted from the image display unit 10. The peripheral aperture 32 transmits a second portion 52 of the light 50. For example, the first subaperture 33a transmits one portion 52a of the light 50. The second subaperture 33b transmits one other portion 52b of the light 50. The one portion 52a of the light 50 and the one other portion 52b of the light 50 are included in the second portion 52.

The light control unit 30 (e.g., the light-shielding unit 35) blocks a portion of the light 50 other than the first portion 51 and the second portion 52, or blocks all portions of the light 50 other than the first portion 51 and the second portion 52.

The distance between the optical unit 20 and the light control unit 30 is taken as a second distance D2 (millimeters). Here, the distance D2 between the optical unit 20 and the light control unit 30 is an optical length. The distance D2 between the optical unit 20 and the light control unit 30 does not always match the physical length between the optical unit 20 and the light control unit 30. In the case where a mirror or the like is disposed on the optical path 50L between the optical unit 20 and the light control unit 30, the distance between the optical unit 20 and the light control unit 30 is the total of the distance between the optical unit 20 and the mirror and the distance between the light control unit 30 and the mirror.

In the embodiment hereinbelow, distances are optical lengths. The distance between multiple components is the distance between the optical centers of the multiple components. For example, a light ray (a central ray) positioned at the center of the light 50 is used as a reference. For example, the distance between a first component and a second component is the distance between the position of the portion of the first component through which the central ray passes and the position of the portion of the second component through which the central ray passes.

The distance (the first distance D1) between the optical unit 20 and the focal position Pf corresponds to the focal distance of the optical unit 20. In the example, the distance along the Z1 axis between the optical unit 20 and the reflective layer 40 is a distance Da1 (millimeters). The distance along the Z2 axis between the reflective layer 40 and the focal position Pf is a distance Db1 (millimeters). The first distance D1 is the sum of the distance Da1 and the distance Db1.

On the other hand, as shown in FIG. 1B, the spacing between the central aperture 31 and the peripheral aperture 32 is taken as an aperture spacing d0 (millimeters). In the case where the peripheral aperture 32 has multiple subapertures 33, the aperture spacing d0 is the minimum value of the distances between the central aperture 31 and the multiple subapertures 33.

In the example shown in FIG. 1B, the multiple subapertures 33 are arranged on a concentric circle. In such a case, the aperture spacing d0 corresponds to the spacing between the first subaperture 33a and the central aperture 31. The aperture spacing d0 corresponds to the spacing between the second subaperture 33b and the central aperture 31. The light (the first portion 51) that passes through the central aperture 31 passes through the focal position Pf to form a focal point at the focal position Pf. The light that passes through the peripheral aperture 32 passes through a location that is different from the focal position Pf. For example, a first peripheral position Pa and a second peripheral position Pb exist on a plane passing through the focal position Pf parallel to the optical path 50L. The light (the one portion 52a of the light 50) that passes through the first subaperture 33a passes through the first peripheral position Pa. The light (the one other portion 52b of the light 50) that passes through the second subaperture 33b passes through the second peripheral position Pb.

In the embodiment, spacing da (millimeters) between the focal position Pf and the first peripheral position Pa and spacing db (millimeters) between the focal position Pf and the second peripheral position Pb are set to be greater than a pupil diameter dp (millimeters). The pupil diameter dp is the diameter of the pupil 82.

In other words, the spacing (the spacing da and the spacing db) on a plane perpendicular to the optical path 50L including the focal position Pf between the light (the first portion 51) that passes through the central aperture 31 and the light (the second portion 52) that passes through the peripheral aperture 32 is set to be greater than the pupil diameter dp.

In other words, the spacing (the aperture spacing d0) between the central aperture 31 and the peripheral aperture 32 of the light control unit 30 is set such that the spacing da and the spacing db are greater than the pupil diameter dp.

The pupil diameter dp changes due to the brightness, etc., of the surroundings of the human viewer 80. In the case where the surroundings are bright, the pupil diameter dp is about 2 mm. In the case where the surroundings are dark, the pupil diameter dp is about 8 mm. In the case where the surroundings have a medium brightness, the pupil diameter dp is, for example, about 5 mm.

For example, in the case where the display device 110 is used at conditions where the surroundings are bright, the spacing (the aperture spacing d0) between the central aperture 31 and the peripheral aperture 32 of the light control unit 30 is set such that the spacing da and the spacing db are greater than 2 mm.

For example, in the case where the display device 110 is used at conditions where the surroundings are dark, the spacing (the aperture spacing d0) between the central aperture 31 and the peripheral aperture 32 of the light control unit 30 is set such that the spacing da and the spacing db are greater than 8 mm.

For example, in the case where the display device 110 is used in conditions where the surroundings have a medium brightness, the spacing (the aperture spacing d0) between the central aperture 31 and the peripheral aperture 32 of the light control unit 30 is set such that the spacing da and the spacing db are greater than 5 mm.

For example, the spacing (the aperture spacing d0) between the central aperture 31 and the peripheral aperture 32 of the light control unit 30 is set such that the spacing da and the spacing db are greater than the minimum pupil diameter dp. According to the embodiment, an easily-viewable display device can be provided. The characteristics of the display device 110 are described below.

FIG. 3 is a schematic view illustrating the display device according to the first embodiment.

FIG. 3 shows the optical disposition of the display device 110. In FIG. 1A, the optical path 50L is bent by the reflective layer 40. FIG. 3 is a model-like illustration of the case where the optical path 50L has a linear configuration by omitting the reflective layer 40.

In the embodiment, the first distance D1 (the focal distance (millimeters) of the optical unit 20), the second distance D2 (the optical length (millimeters)) between the optical unit 20 and the light control unit 30, the spacing (the aperture spacing d0 (millimeters)) between the central aperture 31 and the peripheral aperture 32, and the pupil diameter dp (millimeters) satisfy the following first formula (1).

d0·D1/D2>dp. (1)

The spacing da and the spacing db are greater than the pupil diameter dp when the first formula is satisfied.

For example, in the display device 110, the second formula (2) is satisfied.

d0·D1/D2>2 (mm). (2)

Thereby, the spacing da and the spacing db are greater than 2 mm. Thereby, in the case of being used at conditions where the surroundings are bright, the spacing da and the spacing db are greater than the pupil diameter dp.

For example, in the display device 110, the third formula (3) is satisfied.

d0·D1/D2>8 (mm). (3)

Thereby, the spacing da and the spacing db are greater than 8 mm. Thereby, in the case of being used at conditions where the surroundings are dark, the spacing da and the spacing db are greater than the pupil diameter dp.

For example, in the display device 110, the fourth formula (4) is satisfied.

d0·D1/D2>5 (mm). (4)

Thereby, the spacing da and the spacing db are greater than 5 mm. Thereby, in the case of being used at conditions where the surroundings are medium, the spacing da and the spacing db are greater than the pupil diameter dp.

As illustrated in FIG. 1A, the sum of the distance Da1 and the distance Db1 may be used as the first distance D1.

The display device 110 according to the embodiment includes the display unit (the image display unit 10) that forms the image, the pinhole (the light control unit 30) that transmits a portion of the light from the display unit, and the ocular optical unit (the optical unit 20) for guiding the light that passes through the light control unit 30 toward the eye. The light control unit 30 has the main pinhole (the central aperture 31) for viewing the image, and the peripheral aperture 32 (e.g., the sub-pinholes) provided around the main pinhole. The main pinhole is for viewing the image. The peripheral aperture 32 is for searching for the image.

The light produced by the display unit is bent by the optical unit 20 (e.g., a lens, etc.) after passing through the main pinhole to converge proximally to the pupil plane of the user (the human viewer 80). In the display device 110 according to the embodiment, a focus-free image can be provided because the focus of the lens of the eye 81 is not used. Focus-free images are provided similarly for the light that passes through the sub-pinholes. The focus-free image is viewable in the case where the convergence point is positioned at the pupil of the user. The focus-free image cannot be viewed in the case where the convergence point is not at the pupil of the user.

According to the embodiment, an easily-viewable display device can be provided.

Examples of the characteristics of the display device will now be described.

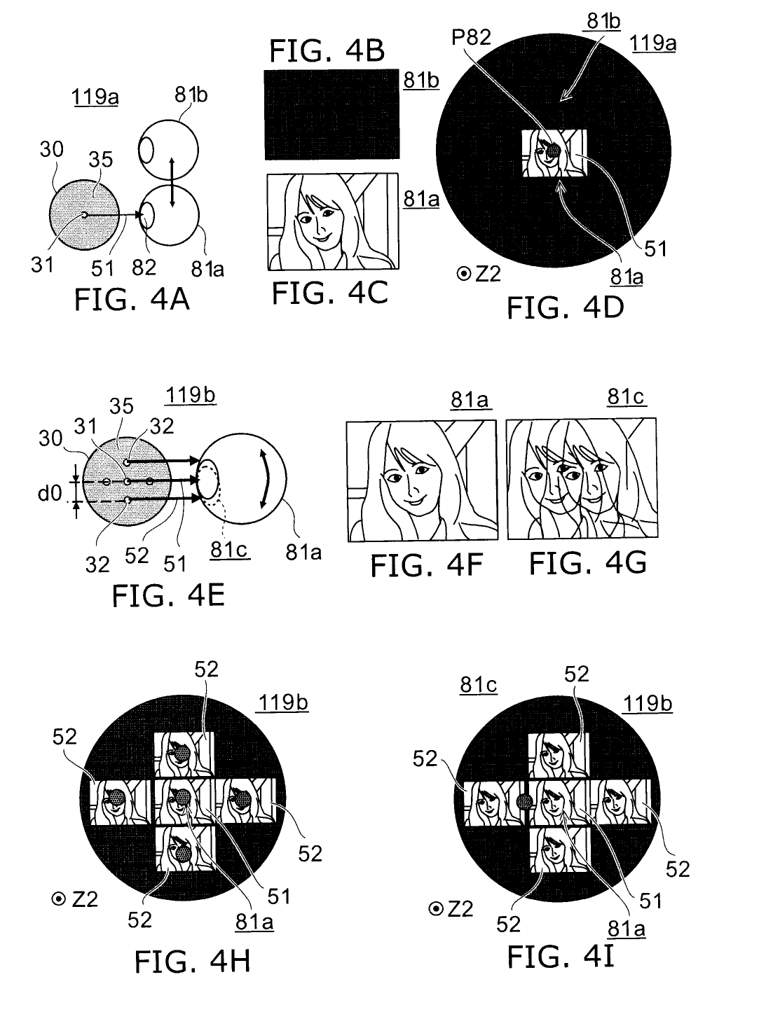

FIG. 4A to FIG. 4I are schematic views showing characteristics of display devices.

FIG. 4A to FIG. 4D show the configuration and the characteristics of a display device 119a of a first reference example.

In the display device 119a as shown in FIG. 4A, the central aperture 31 is provided in the light control unit 30; and the peripheral aperture 32 is not provided. For example, the light-shielding unit 35 is provided; and the central aperture 31 is provided in the light-shielding unit 35.

In the case where the position of the pupil 82 is at a first pupil position 81a in the display device 119a, the light (the first portion 51 of the light 50) is incident on the pupil 82. In the case where the pupil 82 is at a second pupil position 81b, the light is not incident on the pupil 82.

FIG. 4B and FIG. 4C schematically show the states of the images that the human viewer 80 views at the first pupil position 81a and the second pupil position 81b, respectively. As shown in FIG. 4C, the image is viewed at the first pupil position 81a. As shown in FIG. 4B, the image is not viewed at the second pupil position 81b.

FIG. 4D schematically shows the states of the images when the position of the pupil 82 is changed in the case where the image is viewed along the Z2 axis. The image can be viewed when a position P82 of the pupil 82 is proximal to the first pupil position 81a. The image cannot be viewed when the position P82 of the pupil 82 is not at the first pupil position 81a.

Thus, in the case of one pinhole, the viewable region (the viewing zone) is a pinpoint. The viewing zone is narrow. The image cannot be viewed when the position P82 of the pupil 82 is not at the viewing zone of the pinpoint.

When the user is wearing the display device, the position P82 of the pupil 82 does not always match the viewing zone of the pinpoint. Therefore, for example, the user adjusts the mounting state of the display device to match the viewing zone of the pinpoint to the position P82 of the pupil 82. At this time, the user does not know how to adjust the mounting state because the viewing zone is narrow. Therefore, it is difficult to adjust the mounting state.

FIG. 4E to FIG. 4I show the configuration and the characteristics of a display device 119b of a second reference example.

In the display device 119b as shown in FIG. 4E, the central aperture 31 and the peripheral aperture 32 are provided in the light control unit 30. In the display device 119b, the spacing (the aperture spacing d0) between the central aperture 31 and the peripheral aperture 32 is narrow. In the display device 119b, the aperture spacing d0 is set such that the spacing da and the spacing db are not more than 2 mm. For example, the spacing da and the spacing db are less than the pupil diameter dp.

In the example, the image is viewable at the position corresponding to the central aperture 31 and at the position corresponding to the peripheral aperture 32. In other words, the viewing zone of the display device 119b is wider than the viewing zone of the display device 119a. Therefore, it is easier to adjust the mounting state.

As illustrated in FIG. 4E, the light (the first portion 51 of the light 50) is incident on the pupil 82 when the position P82 of the pupil 82 is positioned at the first pupil position 81a(the position corresponding to the central aperture 31). Also, the light (the second portion 52 of the light 50) is incident on the pupil 82 when the position P82 of the pupil 82 is positioned at a position corresponding to the peripheral aperture 32.

However, when the eye 81 is oriented toward the front and the position P82 of the pupil 82 is positioned at the first pupil position 81a, for example, the light (the second portion 52) from the peripheral aperture 32 is incident on the pupil 82 merely by the eye 81 rotating to be oriented toward an oblique direction. In other words, images that are different between the first pupil position 81a of the front and a rotated state 81c which is oblique are undesirably viewed.

For example, as shown in FIG. 4F, the image is viewed normally when the eye 81 is oriented toward the front and the position P82 of the pupil 82 is positioned at the first pupil position 81a.

On the other hand, as shown in FIG. 4G, in the rotated state 81c in which the eye 81 is rotated to be oriented toward the oblique direction, the image of the first portion 51 and the image of the second portion 52 are undesirably viewed according to the rotated state of the eye 81. Therefore, in practical use, viewing is extremely difficult.

In other words, although the viewing zone of the display device 119b enlarges as shown in FIG. 4H, the second portion 52 of the light 50 is undesirably viewed in the rotated state 81c in which the eye 81 is oriented toward the oblique direction even when the position of the eye 81 does not change as shown in FIG. 4I.

Thus, in the display device 119b, the image is undesirably viewed as substantially a double image due to the first portion 51 and the second portion 52 of the light even in the case where the position of the eye 81 does not move, that is, even in the case where the mounting state of the display device does not change. This is because the aperture spacing d0 is small and set such that the spacing da and the spacing db are not more than 2 mm, that is, such that the spacing da and the spacing db are less than the pupil diameter dp.

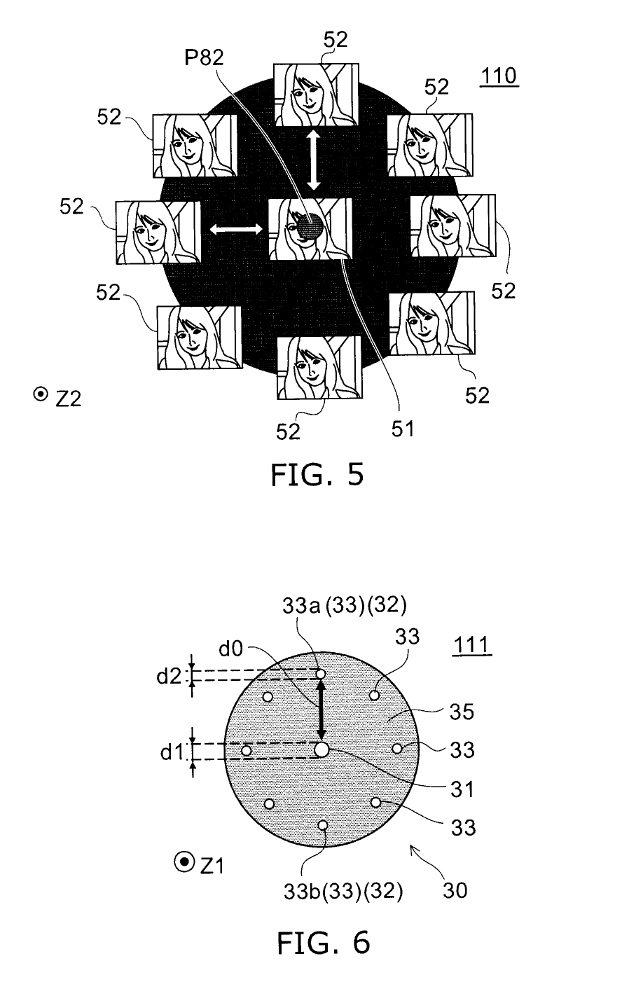

FIG. 5 is a schematic view showing characteristics of the display device according to the first embodiment.

FIG. 5 illustrates the display state of the display device 110 according to the embodiment.

In the display device 110 according to the embodiment, the aperture spacing d0 is set such that the spacing da and the spacing db are greater than 2 mm, that is, such that the spacing da and the spacing db are greater than the pupil diameter dp.

As shown in FIG. 5, the position (the focal position Pf) where the first portion 51 corresponding to the central aperture 31 is incident is separated from the position (e.g., the first peripheral position Pa and the second peripheral position Pb) where the second portion 52 corresponding to the peripheral aperture 32 is incident. In other words, the distance between the two positions is set to be greater than the pupil diameter dp. In the embodiment, the positions of the sub-pinholes are disposed at positions that do not obstruct the image from the main pinhole.

Thereby, even when, for example, the eye 81 rotates, the first portion 51 of the light 50 is incident on the pupil 82; and the second portion 52 is not incident on the pupil 82. In other words, the double image can be suppressed.

Thus, in the embodiment, the viewing zone is enlarged and it is easy to adjust the mounting state by providing the central aperture 31 and the peripheral aperture 32. Further, the double image can be suppressed and an easily-viewable display can be provided by setting the aperture spacing d0 between the central aperture 31 and the peripheral aperture 32 to be greater than the pupil diameter dp.

In the display device 119a as disclosed above, the region (the viewing zone) where the image can be viewed is a pinpoint; and the user does not know where the image is. On the other hand, although the number of the convergence points where the image can be viewed is increased to widen the viewing zone in the display device 119b, the image is viewed as a double image and is difficult to view when the eye moves. Conversely, in the display device 110 according to the embodiment, it is easy to search for the position of the image; and the image is easy to view.

In the embodiment, the distance between the focal position Pf and the first peripheral position Pa and the distance between the focal position Pf and the second peripheral position Pb are excessively large in the case where the aperture spacing d0 is excessively large. Therefore, there are cases where the effect of easily adjusting the mounting state degrades.

In the embodiment, for example, the spacing (the spacing da and the spacing db) between the light (the first portion 51) that passes through the central aperture 31 and the light (the second portion 52) that passes through the peripheral aperture 32 on a plane perpendicular to the optical path 50L including the focal position Pf is set to be not more than 2 times the pupil diameter dp. Thereby, the aperture spacing d0 is not excessively large; and an easier adjustment of the mounting state can be obtained effectively.

For example, the first distance D1 (the focal distance of the optical unit 20), the second distance D2 (the optical length) between the optical unit 20 and the light control unit 30, and the spacing (the aperture spacing d0) between the central aperture 31 and the peripheral aperture 32 satisfy the following fifth formula (5).

d0·D1/D2<2·dp. (5)

For example, in the case where the display device 110 is used at conditions where the surroundings are bright, the sixth formula (6) is satisfied.

d0·D1/D2<4 (mm). (6)

For example, in the case where the display device 110 is used at conditions where the surroundings are dark, the seventh formula (7) is satisfied.

d0·D1/D2<18 (mm). (7)

For example, in the case where the display device 110 is used at conditions where the surroundings are a medium brightness, the eighth formula (8) is satisfied.

d0·D1/D2<10 (mm). (8)

Thereby, the conditions of use are matched; the aperture spacing d0 is not excessively large; and an easier adjustment of the mounting state can be obtained effectively.

On the other hand, the width (the width in a direction orthogonal to the optical path 50L) of the central aperture 31 is set to be not less than 0.2 mm and not more than 1 mm. Thereby, for example, the display of a substantially focus-free image can be provided. In the case where the width of the central aperture 31 is less than 0.2 mm, for example, the effects of diffraction occur; and the image quality decreases. In the case where the width of the central aperture 31 is greater than 1 mm, for example, the optical system becomes an imaging optical system that uses the adjustment by the lens of the eye; and the focus-free effect is lost.

FIG. 6 is a schematic view illustrating another display device according to the first embodiment.

FIG. 6 illustrates the light control unit 30 of the display device 111 according to the embodiment. As shown in FIG. 6, the peripheral aperture 32 has the multiple subapertures 33 (the first subaperture 33a, the second subaperture 33b, etc.).

A width d2 of each of the multiple subapertures 33 is narrower than a width d1 of the central aperture 31. The width d2 is the width (the length) of the multiple subapertures 33 in a direction orthogonal to the optical path 50L. The width d1 is the width (the length) of the central aperture 31 in the direction orthogonal to the optical path 50L.

In the case where the diameter of the main pinhole is the same as the sub-pinhole diameter, the luminance of the light from the main pinhole is substantially equivalent to the luminance of the light from the sub-pinholes. Therefore, there are cases where it is difficult to know which light is the light from the main pinhole.

Conversely, in the display device 111, the diameter of the sub-pinholes is set to be less than the diameter of the main pinhole. Thereby, the luminance of the light from the main pinhole is higher than the luminance from the sub-pinholes. Thereby, the discrimination between the light from the main pinhole and the light from the sub-pinholes is easier. For example, the adjustment of the mounting state is easier; and the device is easier to use.

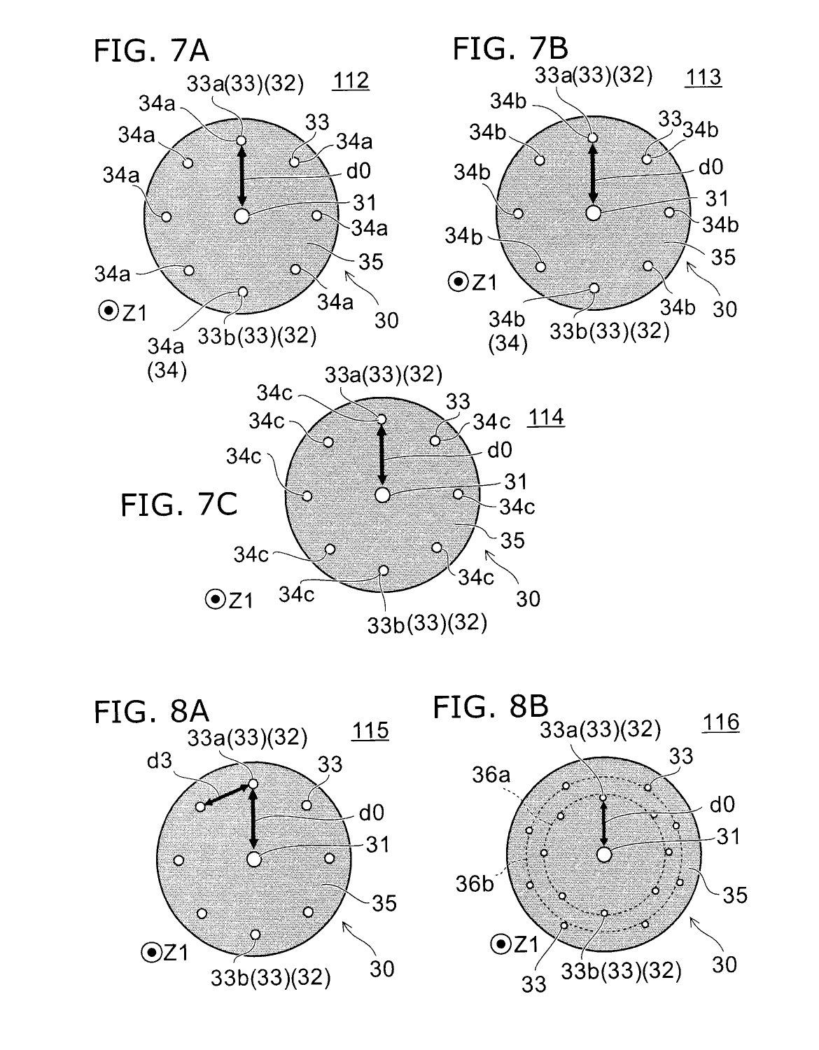

FIG. 7A to FIG. 7C are schematic views illustrating other display devices according to the first embodiment.

These drawings illustrate the light control unit 30.

In a display device 112 according to the embodiment as shown in FIG. 7A, the light control unit 30 further includes an optical layer 34. In the example, a ND filter 34a is used as the optical layer 34. For example, the optical layer 34 (the ND filter 34a) overlaps the peripheral aperture 32 on the optical path 50L. The ND filter 34a changes the intensity of the light (the second portion 52) that passes through the peripheral aperture 32. For example, the ND filter 34a reduces the intensity of the second portion 52.

In a display device 113 according to the embodiment as shown in FIG. 7B, a color filter 34b is used as the optical layer 34. For example, the color filter 34b changes the wavelength distribution of the light (the second portion 52) that passes through the peripheral aperture 32.

In a display device 114 according to the embodiment as shown in FIG. 7C, a diffusion filter 34c is used as the optical layer 34. For example, the diffusion filter 34c changes the diffusability of the light (the second portion 52) that passes through the peripheral aperture 32. For example, the diffusability of the light after passing through the diffusion filter 34c is greater than the diffusability of the light prior to passing through the diffusion filter 34c.

In the display devices 112 to 114 as well, the discrimination between the light from the main pinhole and the light from the sub-pinholes is easier. For example, the adjustment of the mounting state is easier; and the device is easier to use.

In the embodiment, a layer that changes at least one selected from the intensity, the wavelength distribution, or the diffusability of the light that passes through the peripheral aperture 32 may be used as the optical layer 34.

In the display devices 112 to 114, the luminance of the light that passes through each of the sub-pinholes is lower than the luminance of the light that passes through the main pinhole. Thereby, it is easier to search for the image of the main pinhole.

FIG. 8A to FIG. 8B are schematic views illustrating other display devices according to the first embodiment.

These drawings illustrate the light control unit 30.

In a display device 115 according to the embodiment as shown in FIG. 8A, spacing d3 between two most proximal subapertures 33 is less than the aperture spacing d0. The spacing between the sub-pinholes is narrow. Thereby, it is easier to search for the light (the image) from the main pinhole. Thus, it is easy to search for the image when the spacing between the sub-pinholes is narrow.

In a display device 116 according to the embodiment as shown in FIG. 8B, the multiple subapertures 33 are provided in the peripheral aperture 32 of the light control unit 30. In the example, the multiple subapertures 33 are provided along two concentric circles (a first concentric circle 36a and a second concentric circle 36b).

In other words, a portion of the multiple subapertures 33 is arranged along the first concentric circle 36a that has the central aperture 31 as a center. Another portion of the multiple subapertures 33 is arranged along the second concentric circle 36b that has the central aperture 31 as a center and is on the outer side of the first concentric circle 36a.

In the display device 116, the width of the subapertures 33 arranged along the first concentric circle 36a may be different from the width of the subapertures 33 arranged along the second concentric circle 36b. For example, the former is greater than the latter. Thereby, it is easier to search for the light (the image) from the main pinhole.

Thus, the width of each of the multiple subapertures 33 in a direction orthogonal to the optical path 50L may change as the distance between the central aperture 31 and each of the multiple subapertures 33 changes.

In the embodiment, the range where the image can be searched for increases further by increasing the number of sub-pinholes at the periphery. It is even easier to direct the eye toward the image of the main pinhole by changing the diameter, color, and/or brightness of the sub-pinholes according to the distances of the sub-pinholes from the main pinhole.

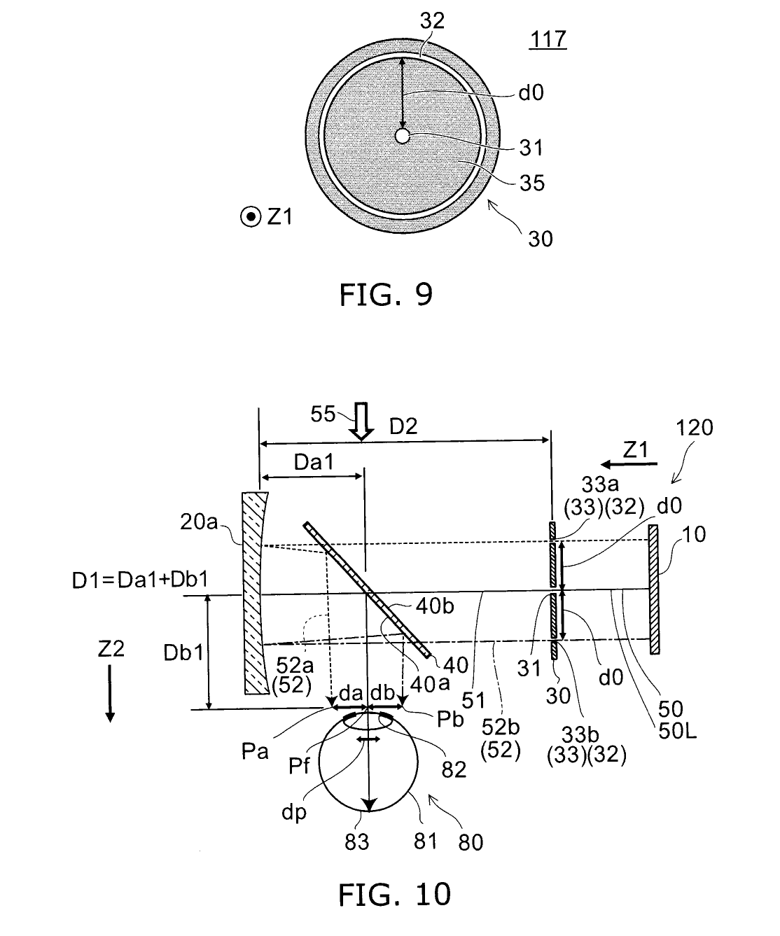

FIG. 9 is a schematic view illustrating another display device according to the first embodiment.

The drawing illustrates the light control unit 30.

In the display device 117 according to the embodiment as shown in FIG. 9, the peripheral aperture 32 extends along a circle having the central aperture 31 as a center. The peripheral aperture 32 has, for example, an annular configuration. In such a case as well, it becomes easier to direct the eye toward the image of the main pinhole.

The optical layer 34 may be provided in the display devices 115 to 117.

### Second Embodiment

FIG. 10 is a schematic view illustrating a display device according to a second embodiment.

In the display device 120 according to the embodiment as shown in FIG. 10, a concave mirror is used as the optical unit 20a. Also, the reflective layer 40 is provided in this example. The disposition angle of the reflective layer 40 of the display device 120 is rotated 90 degrees with respect to the disposition angle of the reflective layer 40 of the display device 110. Otherwise, the display device 120 is similar to the display device 110, and a description is therefore omitted.

The light control unit 30 is provided in the display device 111 as well. The light control unit 30 has the central aperture 31 and the peripheral aperture 32. The configuration of the light control unit 30 is similar to, for example, the configuration of the light control unit 30 of the display device 110. The configuration of the light control unit 30 described in regard to the display devices 111 to 117 is applicable to the display device 120.

In the display device 120, the distance along the Z1 axis between the optical unit 20a and the reflective layer 40 is the distance Da1 (millimeters). The distance along the Z2 axis between the reflective layer 40 and the focal position Pf is the distance Db1 (millimeters). In the example as well, the first distance D1 (millimeters) is the sum of the distance Da1 and the distance Db1. On the other hand, the second distance D2 (millimeters) is the distance between the optical unit 20a and the light control unit 30. Then, the aperture spacing d0 (millimeters) between the central aperture 31 and the peripheral aperture 32 is defined.

The first distance D1, the second distance D2, the aperture spacing d0, and the pupil diameter dp (millimeters) satisfy the first formula recited above. The spacing da and the spacing db are greater than the pupil diameter dp. Thereby, an easily-viewable display device can be provided.

In the display device 120, the second to fourth formulas recited above may be satisfied according to the conditions in which the display device 120 is used.

Also, the fifth to eighth formulas recited above may be satisfied in the display device 120.

According to the embodiments, an easily-viewable display device can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in display devices such as an image display unit, an optical unit, a light control unit, an optical layer, a reflective layer and a holder, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all display devices practicable by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device, comprising:
an image display configured to emit light including an image;
an optical component having a focal distance D1; and
a light control component provided between the image display and the optical component on an optical path of the light, the light control component including:
a central aperture configured to transmit a first portion of the light emitted from the image display; and
a peripheral aperture provided around the central aperture, the peripheral aperture being configured to transmit a second portion of the light,
the light control component being configured to block a portion of the light other than the first portion and the second portion,
the focal distance D1 (millimeters), a distance D2 (millimeters) between the optical component and the light control component, and an aperture spacing d0 (millimeters) between the central aperture and the peripheral aperture being configured to satisfy a relationship:
d0·D1/D2>2 (millimeters).

2. The device according to claim 1, wherein a width of the central aperture in a direction orthogonal to the optical path is not less than 0.2 millimeters and not more than 1 millimeter.

3. The device according to claim 1, wherein
the peripheral aperture includes a plurality of subapertures, and
the aperture spacing d0 is a minimum value of distances between the central aperture and each of the subapertures.

4. The device according to claim 3, wherein a width of each of the subapertures in a direction orthogonal to the optical path is less than a width of the central aperture in the direction orthogonal to the optical path.

5. The device according to claim 3, wherein a width of each of the subapertures in a direction orthogonal to the optical path changes with the distances between the central aperture and each of the subapertures.

6. The device according to claim 3, wherein a spacing between two most proximal subapertures is less than the aperture spacing d0.

7. The device according to claim 3, wherein
a portion of the subapertures is arranged along a first concentric circle having the central aperture as a center, and
another portion of the subapertures is arranged along a second concentric circle on an outer side of the first concentric circle, the second concentric circle having the central aperture as a center.

8. The device according to claim 1, wherein the peripheral aperture extends along a circle having the central aperture as a center.

9. The device according to claim 1, wherein the light control component further includes an optical layer overlapping the peripheral aperture on the optical path, the optical layer being configured to change an intensity of the light passing through the peripheral aperture.

10. The device according to claim 1, wherein the light control component further includes an optical layer overlapping the peripheral aperture on the optical path, the optical layer being configured to change a wavelength distribution of the light passing through the peripheral aperture.

11. The device according to claim 1, wherein the light control component further includes an optical layer overlapping the peripheral aperture on the optical path, the optical layer being configured to change a diffusability of the light passing through the peripheral aperture.

12. The device according to claim 1, further comprising a reflective layer provided on the optical path between the light control component and a position separated from the optical component by the focal distance, the reflective layer having a first major surface and a second major surface, the second major surface being on a side opposite to the first major surface, the reflective layer being configured to reflect the light at the first major surface and transmit at least a portion of light incident on the second major surface.

13. The device according to claim 1, wherein the focal distance D1, the distance D2, and the aperture spacing d0 satisfy a relationship:
d0·D1/D2>5 (millimeters).

14. The device according to claim 1, wherein the focal distance D1, the distance D2, and the aperture spacing d0 satisfy a relationship:
d0·D1/D2>8 (millimeters).

15. The device according to claim 1, wherein the focal distance D1, the distance D2, and the aperture spacing d0 satisfy a relationship:
d0·D1/D2<4 (millimeters).

16. The device according to claim 1, wherein the focal distance D1, the distance D2, and the aperture spacing d0 satisfy a relationship:
d0·D1/D2<10 (millimeters).

17. The device according to claim 1, wherein the optical component includes a convex lens.

18. The device according to claim 1, wherein the optical component includes a concave mirror.

19. The device according to claim 1, further comprising a holder configured to hold the image display, the optical component, and the light control component to regulate a spatial disposition between the light control component and an eye of a human viewer, light emitted from the light control component being incident on the eye of the human viewer.

20. The device according to claim 19, wherein the holder includes a holding member configured to contact a head of the human viewer.
